(19) United States
(12) Patent Application Publication
(10) Pub. No.: US 2019/0210196 A1
(43) Pub. Date: Jul. 11, 2019

(54) DAMAGED SCREW MEMBER REMOVING TOOL

(71) Applicant: MENG-YU LAI, Taichung City (TW)

(72) Inventor: MENG-YU LAI, Taichung City (TW)

(21) Appl. No.: 15/866,498

(22) Filed: Jan. 10, 2018

(51) Int. Cl. B25B 13/48; B25B 13/06

(52) U.S. Cl. CPC B25B 13/48; B25B 13/065

(57) ABSTRACT

A damaged screw member removing tool includes a main body having a hollow mounting portion at one end thereof, and an engage structure disposed in the mounting portion and having a plurality of forcing units with a recess portion disposed between each two of the forcing units. Each forcing unit includes a first and a second forcing faces connected to include an included angle therebetween. The first forcing face has a first forcing point at a lateral side thereof. The second forcing face has a second forcing point at a lateral side thereof. When the mounting portion is mounted on a damaged screw member, the first forcing face contacts a damaged corner of the damaged screw member, and the second forcing point rests on a lateral face of the damaged screw member, with other damaged corners housed in the recess portions.

### BACKGROUND OF THE INVENTION

### 1. Field of the invention

The present invention relates to hand tools, and more particularly, to a damaged screw member removing tool.

### 2. Description of the Related Art

Screw member is a necessary component nowadays. Common screw members include screw, nut, and bolt. Tools applied for driving screw members include wrench, sleeve, or clamp, wherein the sleeve is the commonest tool which is applied with a wrench. By mounting the sleeve on the screw head or the nut, the user drives the wrench to trigger the rotation of the sleeve, such that the sleeve drives the screw member altogether, achieving a fastening or loosening operation. However, the screw member is rusted after a long period of usage or having the corners thereof damaged after a frequent usage. If a conventional wrench is applied to drive the damaged screw member, the wrench fails to stably engage the screw member. As a result, a slipping issue occurs between the wrench and the screw member, and the screw member is prevented from being easily removed.

Further, the conventional tool for removing damaged screw members is unidirectionally operated. Due to the space limitation of the operation field, when a reversely-driven operation is needed, the conventional tool fails to meet the operation requirement. Also, when such conventional tool is to be applied to undamaged screw member, outer corners of the screw member are possibly damaged. Therefore, it is desirable to provide a removing tool for damaged screw members which is applicable to damaged and undamaged screw members and operable with ether of the two faces thereof facing upward.

### SUMMARY OF THE INVENTION

For improving the issues above, the present invention discloses a damaged screw member removing tool, which is applicable to damaged and undamaged screw members and operable with ether of the two faces thereof facing upward.

To achieve the aforementioned objectives, a damaged screw member removing tool in accordance with an embodiment of the present invention is provided, comprising:

a main body provided with a hollow mounting portion disposed at one end thereof; and

an engage structure disposed in the mounting portion, the engage structure including a plurality of forcing units with a recess portion disposed between each two of the forcing units, each forcing unit including a first forcing face and a second forcing face symmetrically disposed, the first forcing face and the second forcing face connected to include an included angle, the first forcing face having a first forcing point at a lateral side thereof, the second forcing face having a second forcing point at a lateral side thereof;

when the mounting portion is mounted on a damaged screw member, the first forcing face contacts a damaged corner of the damaged screw member, and the second forcing point rests on a lateral face of the damaged screw member, such that other damaged corners of the damaged screw member are housed in the recess portions.

In an embodiment of the present invention, a housing groove is disposed at the connection junction between the first forcing face and the second forcing face.

In an embodiment of the present invention, the mounting portion is formed in a open structure and provided with an opening disposed between two neighboring first forcing faces.

In an embodiment of the present invention, the main body includes a handle which is connected with the mounting portion. The mounting portion is bent toward the handle by an angle smaller than 20 degrees.

With such configuration, when the mounting portion is mounted on the damaged screw member, the first forcing face contacts the damaged corner of the damaged screw member, and the second forcing point rests on a lateral face of the damaged screw member, such that other corners of the damaged screw member are housed in the recess portions. With the first forcing face increasing the fraction and the pushing force of the second forcing point, the damaged screw member allowed to be easily fastened and removed. Additionally, when the present invention is applied to an undamaged screw member, the housing grooves and the recess portions are able to house the corners of the screw member, resolving the issue of the conventional removing tool being unable to be applied to undamaged screw members, enhancing the utility of the present invention.

Furthermore, when the present invention is applied to a box wrench, the mounting portion is formed in a sealed shape, and the mounting portion is bent toward the handle by an angle smaller than 20 degrees. Therefore, the present invention is allowed to be used with ether of the two faces thereof facing upward, and the operation space is not limited in a certain environment, improving the convenience of usage. Also, beside the box wrench, the present invention is also applicable to a sleeve or open-end wrench. When applied to an open-end wrench, the mounting portion is provided with an opening, such that the mounting portion is able to be mounted on the damaged screw member from a lateral direction for removing the damaged screw member, further improving the convenience of usage.

### BRIEF DESCRIPTION OF THE DRAWINGS

FIG. 1 is a partial perspective view of the damaged screw member removing tool in accordance with an embodiment of the present invention.

FIG. 2 is a side view of the damaged screw member removing tool, illustrating the bending angle between the mounting portion and the handle.

FIG. 3 is a tip view of the damaged screw member removing tool in accordance with an embodiment of the present invention.

FIG. 4 is a schematic view illustrating the removing tool mounted on a damaged screw member, wherein the main body is not driven to rotate.

FIG. 5 is a schematic view illustrating the removing tool mounted on a damaged screw member, wherein the main body is driven to rotate by the front face of the removing tool.

FIG. 6 is a schematic view illustrating the removal tool mounted on a damaged screw member, wherein the main body is driven to rotate by the rear face of the removing tool.

FIG. 7 is a schematic view illustrating the removing tool mounted on an undamaged or partially screw member.

FIG. 8 is a schematic view illustrating the removing tool mounted on a sleeve.

FIG. 9 is a schematic view of the removing tool in accordance with another embodiment of the present invention, illustrating the mounting portion provided with an opening.

### DETAILED DESCRIPTION OF THE INVENTION

The aforementioned and further advantages and features of the present invention will be understood by reference to the description of the preferred embodiment in conjunction with the accompanying drawings where the components are illustrated based on a proportion for explanation but not subject to the actual component proportion.

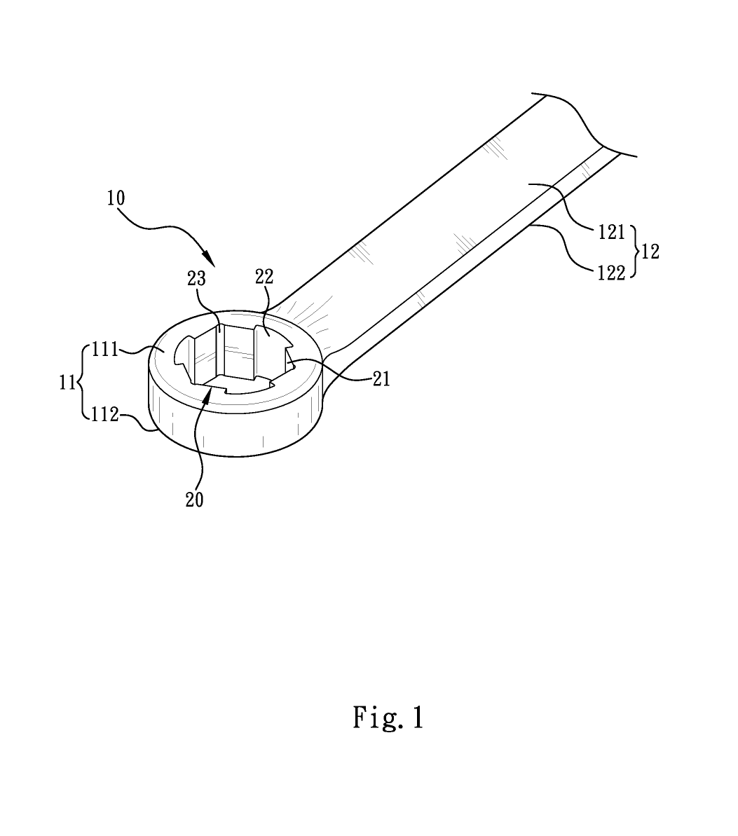

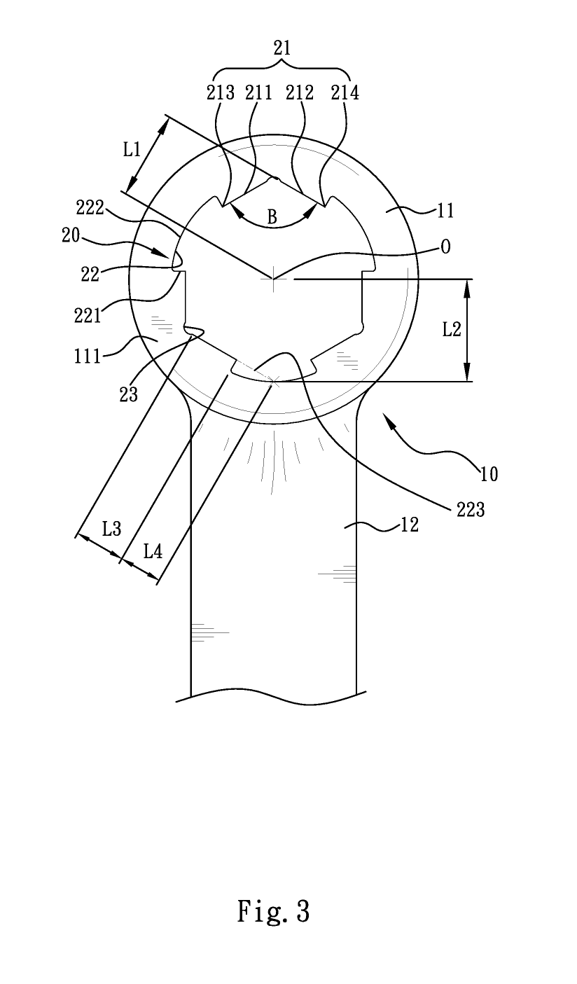

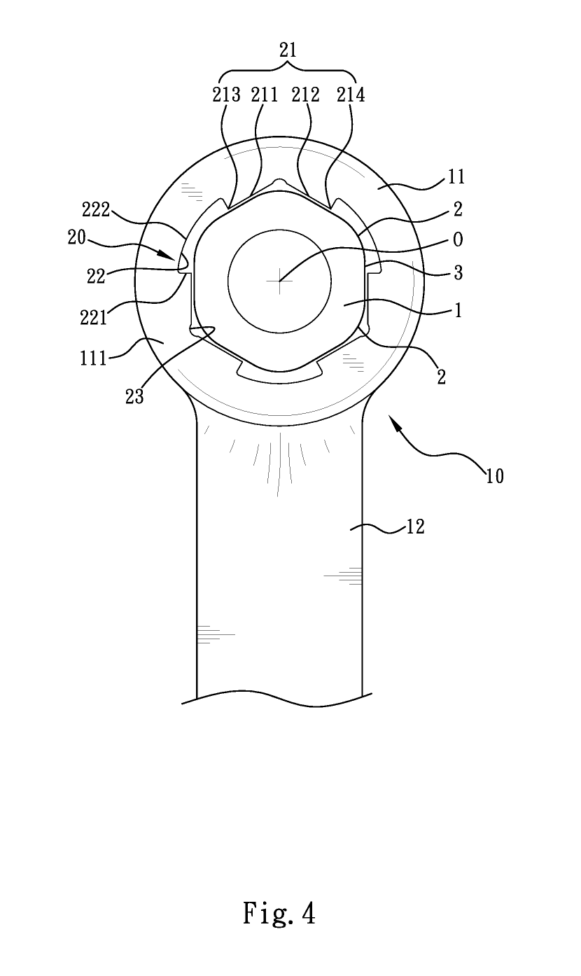

Referring to FIG. 1 to FIG. 8, a damaged screw member removing tool in accordance with an embodiment of the present invention comprises a main body 10 and an engage structure 20.

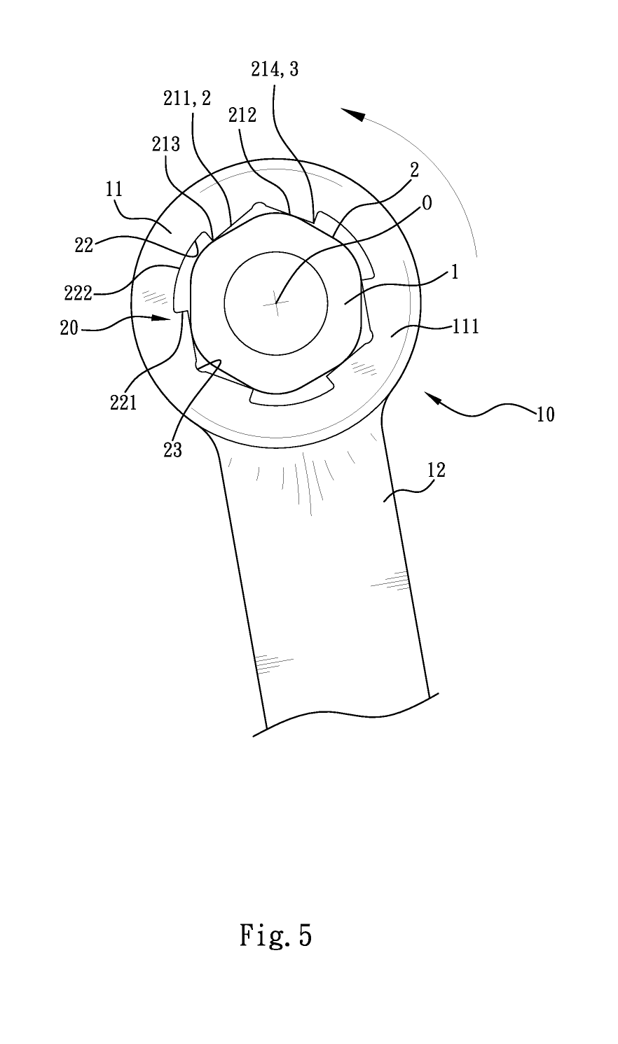

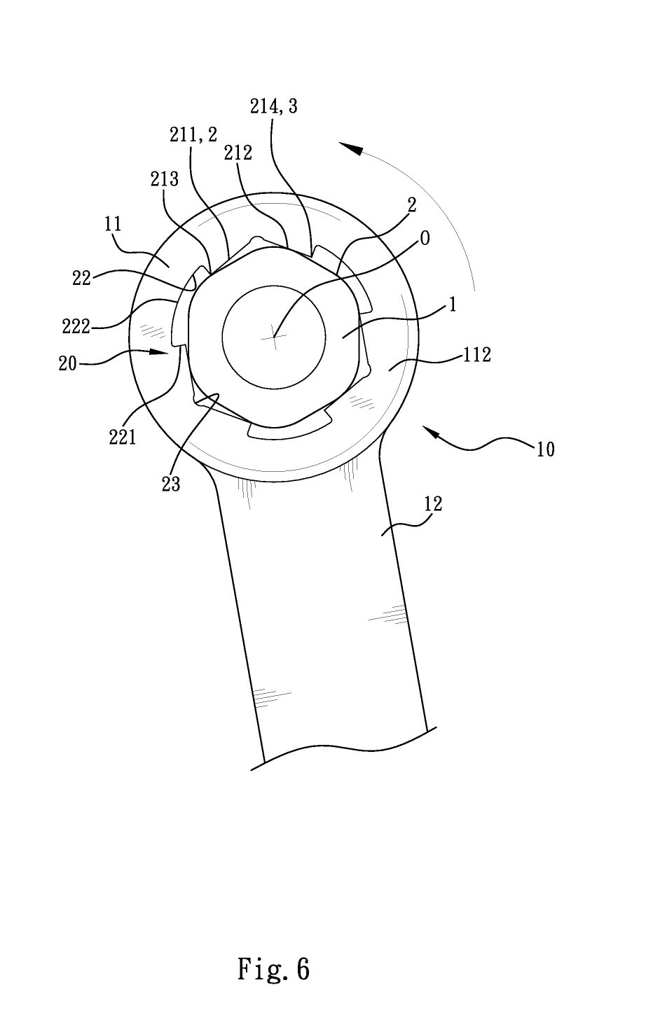

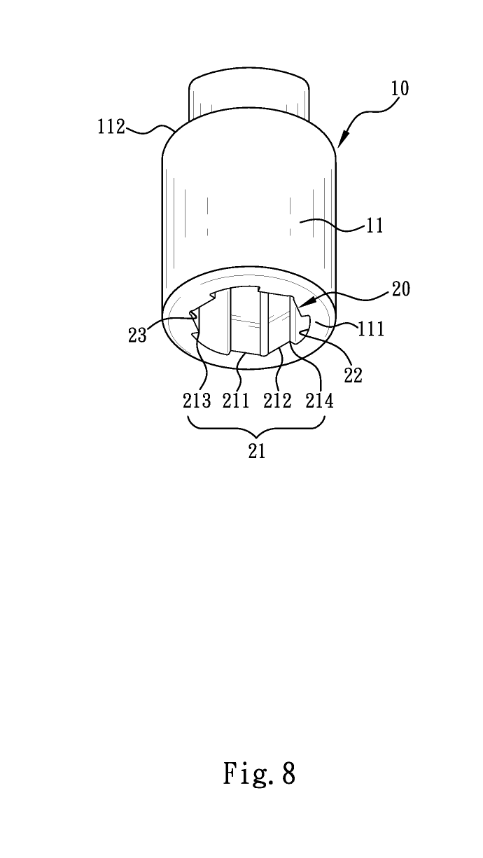

The main body 10 is provided with a hollow mounting portion 11 disposed at one end thereof and a handle 12 connected with the mounting portion 11. The mounting portion 11 is bent toward the handle 12 by a bending angle A, wherein the bending angle A is smaller than 20 degrees. Referring to FIG. 1 to FIG. 6, the main body 10 is a box wrench, and the mounting portion 11 is a sealed column provided with a front face 111 and an opposite rear face 112. The handle 12 is formed in a rectangular shape and provided with a first face 121 and an opposite second face 122. The front face 111 of the mounting portion 11 is bent toward the first face 121 of the handle 12, and the bending angle A by which an extension of the rear face 112 of the mounting portion 11 included with the second face 122 of the handle 12 is smaller than 20 degrees. In an embodiment of the present invention, the bending angle A is 10 degrees. Therefore, with the bending angle A of the mounting portion 11, the present invention is allowed to be operated with ether of the two faces thereof facing upward in a non-limited operation environment. As shown by FIG. 5, the main body 10 is operated with the front face 111 thereof facing upward. As shown by FIG. 6, the main body 10 is operated with the rear face 112 thereof facing upward. As shown by FIG. 8, when the main body 10 is a sleeve, the main body 10 is formed in a column shape.

The engage structure 20 is disposed in the mounting portion 11 and provided with a plurality of forcing units 21, with a recess portion 22 disposed between each two forcing unit 21. Each forcing unit 21 includes a first forcing face 211 and a second forcing face 212, wherein the first forcing face 211 is connected with the second forcing face 212. Also, the first forcing face 211 and the second forcing face 212 are symmetrically arranged along the line extend from the rotation center O, with an included angle B included therebetween, wherein the included angle B ranges from 90 degrees to 180 degrees. In an embodiment of the present invention the forcing units 21 are provided in an amount of three, and the recess portions 22 are provided in an amount of three. The first forcing face 211 and the second forcing face 212 are formed in a planar shape, and the included angle B is 120 degrees. Further, the first forcing face 211 has a first forcing point 213 disposed at a lateral side thereof, and the second forcing face 212 has a second forcing point 214 disposed at a lateral side thereof.

Referring to FIG. 5 and FIG. 6, when the user mounts the mounting portion 11 of the main body 10 on a damaged screw member 1 and holds the handle 12 to drive the handle 12 to rotate clockwise against the rotation center O of the mounting portion 11, the first forcing face 211 contacts the damaged corner 2 of the damaged screw member 1. At the same time, each second forcing point 214 rests on the lateral face 3 of the damaged screw member 1, such that other damaged corners 2 of the damaged screw member 1 are housed in the recess portions 22. With the first forcing face 211 increasing the fraction and the pushing force imposed by the second forcing point 214, the damaged screw member 1 is allowed to be easily fastened and removed. In contrast, when the damaged screw member 1 is to be loosened, the mounting portion 11 of the main body 10 is mounted on the damaged screw member 1, and the handle 12 is driven to rotate counterclockwise against the rotation center O of the mounting portion 11. The second forcing face 212 contacts the damaged corner 2 of the damaged screw member 1. At the same time, the first forcing point 213 rests on the lateral face 3 of the damaged screw member 1, such that other damaged corners 2 of the damaged screw member 1 are housed in the recess portions 22. Therefore, the damaged screw member 1 is allowed to be easily loosened.

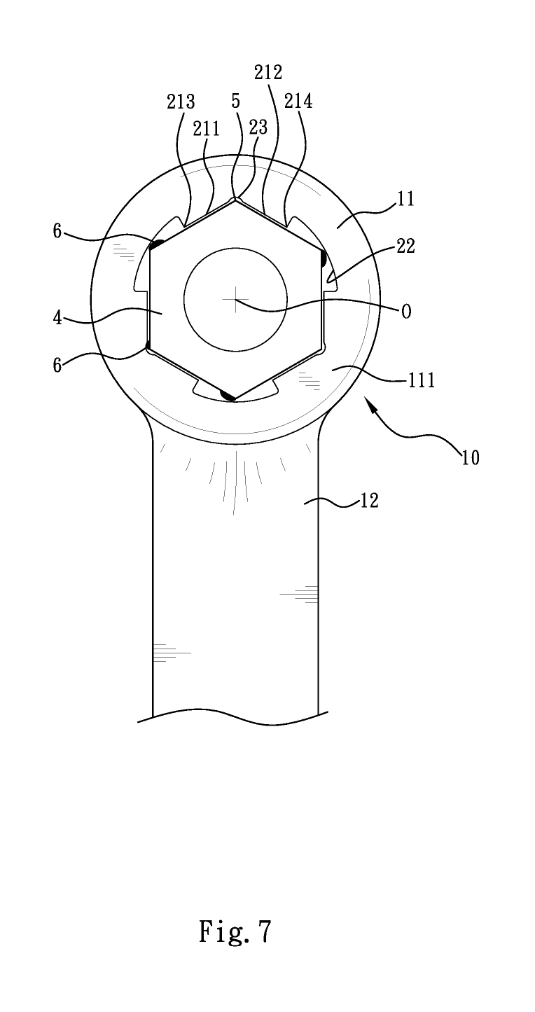

Furthermore, a housing groove 23 is disposed at the connection junction between the first forcing face 211 and the second forcing face 212, with the first forcing point 213 arranged at one side of the first forcing face 211 away from the housing groove 23, and the second forcing point 214 arranged at one side of the second forcing face 212 away from the housing groove 23. In an embodiment of the present invention, the housing groove 23 is formed in an arc shape. Therefore, as shown by FIG. 7, when the present invention is applied to an undamaged screw member 4, the first forcing face 211 and the second forcing face 212 rest on an edge of the undamaged screw member 4, such that the housing grooves 23 and the recess portions 22 house the side corners 5 of the undamaged screw member 4. Also, as shown by FIG. 7, when the side corners 5 of the undamaged screw member 4 have burrs due to abrasion, the partially damaged corners 6 having the burr are allowed to be housed in the recess portions 22 or the housing grooves 23. Therefore, the present invention is applicable to damaged screw members 1, undamaged screw members 4, and partially damaged corners 6 of the undamaged screw members 4, thus improving the convenience of usage.

Also, the recess portion 22 is provided with two lateral sides 221 and an arc section 222 disposed between the two lateral sides 221. The two lateral sides 221 are connected with the first forcing face 211 and the second forcing face 212, respectively. The vertical distance from the first forcing face 211 or the second forcing face 212 to the rotation center O of the mounting portion 11 is defined as a first length L1. The vertical distance from the arc section 222 to the rotation center O of the mounting portion 11 is defined as a second length L2. The second length L2 is larger than the first length L1, and the second length L2 is larger than 1.1 to 1.5 times the first length L1. In an embodiment of the present invention, the second length L2 is larger than 1.2 times the first length L1. Further, the first forcing point 213 is disposed at the junction between the first forcing face 211 and one of the lateral sides 221; the second forcing point 214 is disposed at the junction of the second forcing face 212 and the other later side 221. The length of the two lateral sides 221 is smaller than length of the first forcing face 211 and the second forcing face 212. The first forcing face 211 and the second forcing face 212 include a 90 degrees angle with the two lateral sides 221, respectively.

Moreover, the length of the first forcing face 211 and the second forcing face 212 is defined as a third length L3. A straight line extending from the first forcing point 213 or second forcing point 214 to the middle point of the arc section 222 is defined as an extension line 223, wherein the length of the extension line 223 is defined as a fourth length L4. The third length L3 is larger than the fourth length L4, and the third length L3 is larger than 1.5 to 2 times the fourth length L4. In an embodiment of the present invention, the third length L3 is larger than 1.5 times the fourth length L4. With such configuration, a rotation space is provided to the other undamaged corners 2 of the damaged screw member 1 or the side corners 5 of the undamaged screw member 4. Therefore, the present invention is applicable to both the undamaged screw member 4 and the damaged screw member 1, improving the utility of the present invention.

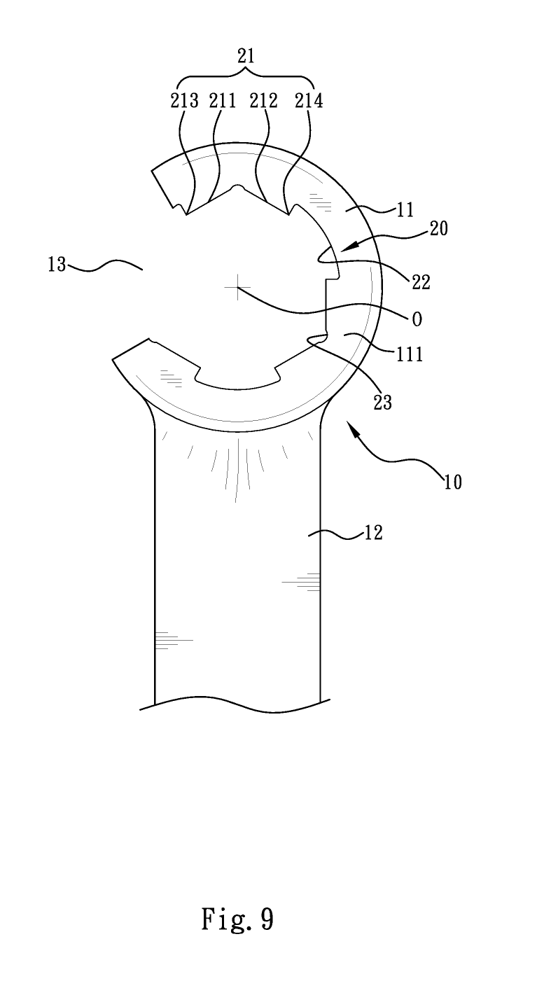

FIG. 9 illustrates the damaged screw member removing tool in accordance with another embodiment of the present invention. The numeric of identical or similar components of the aforementioned embodiment are omitted for the clearance of illustration.

The main body 10 is an open-end wrench. Therefore, the mounting portion 11 of the main body 10 is formed in an open shape and provided with an opening 13, which is disposed between two neighboring first forcing faces 211. In an embodiment of the present invention, the first forcing faces 211 are provided in an amount of three; the first forcing points 213 are provided in an amount of three; the second forcing faces 212 are provided in an amount of two, the second forcing points 214 are provided in an amount of two; and the recess portions 22 are provided in an amount of two. Therefore, the mounting portion 11 is able to be mounted on the damaged screw member 1 from a lateral direction. When the damaged screw member 1 is to be fastened, the user drives the handle 12 to rotate clockwise against the rotation center O of the mounting portion 11, such that the first forcing face 211 contacts the damaged corner 2 of the damaged screw member 1, and the second forcing point 214 rests on the lateral face 3 of the damaged screw member 1, with the undamaged corners 5 of the damaged screw member 1 housed in the recess portions 22. With the first forcing face 211 increasing the fraction and the pushing force of the second forcing point 214, the damaged screw member 1 is allowed to be easily fastened and removed. When the handle 12 is reversely operated, the damaged screw member 1 is loosened.

Referring to FIG. 5 and FIG. 6, when the damaged screw member 1 is to be fastened, the mounting portion 11 of the main body 10 is mounted on the damaged screw member 1, and the user drives the handle 12 to rotate clockwise against the rotation center O of the mounting portion 11, such that the first forcing face 211 contacts the d art aged corner 2 of the damaged screw member 1, and the second forcing point 214 rests on the lateral face 3 of the damaged screw member 1, with the other damaged corners 2 of the damaged screw member 1 housed in the recess portions 22. With the first forcing face 211 increasing the fraction and the pushing force of the second forcing point 214, the damaged screw member 1 is allowed to be easily fastened and removed. When the handle 12 is driven to rotate counterclockwise against the rotation center O of the mounting portion 11, the damaged screw member 1 is easily loosened to be removed.

Also, referring to FIG. 7, when the present invention is applied to the undamaged screw member 4 having or not having the partially damaged corner 6, the housing grooves 23 and the recess portions 22 are able to house the side corners 5 or the partially damaged corners 6 of the undamaged screw member 4. The issue of conventional damaged screw member removing tool 1 being unable to be applied to he undamaged screw member 4 is resolve, improving the utility of the present invention.

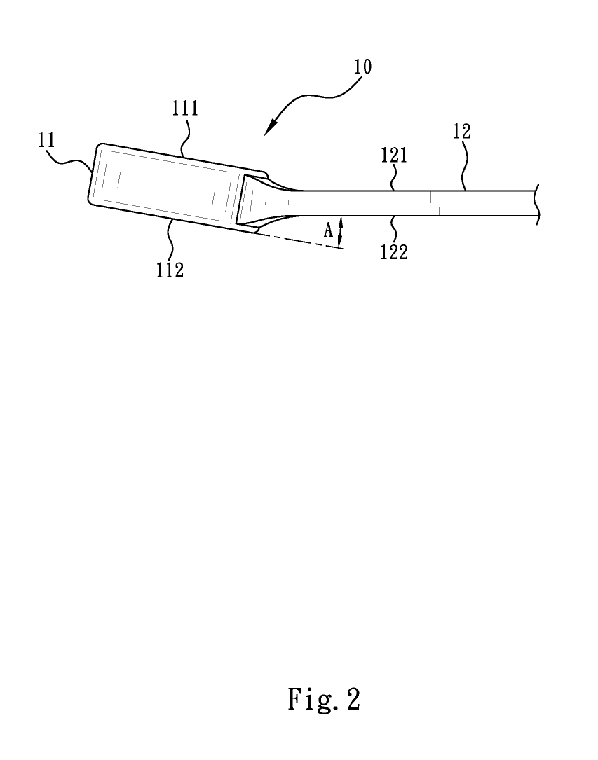

Furthermore, referring to FIG. 2, with the mounting portion 11 being bent toward the handle 12 by a bending angle A smaller than 20 degrees, the present invention is operable with ether of the front face 111 or the rear face 112 facing upward, without being limited by the operation environment limitation. Also, referring to FIG. 9, the present invention is applicable to not only box wrenches and sleeves, but also open-end wrenches. With the mounting portion 11 provided with the opening 13, the mounting portion 11 is allowed to be mounted on the damaged screw member 1 from a lateral direction for removing the damaged screw member 1. Therefore, the utility of the present invention is improved.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A damaged screw member removing tool, comprising:
a main body provided with a hollow mounting portion disposed at one end thereof; and
an engage structure disposed in the mounting portion, the engage structure including a plurality of forcing units with a recess portion disposed between each two of the forcing units, each forcing unit including a first forcing face and a second forcing face symmetrically disposed, the first forcing face and the second forcing face connected to include an included angle, the first forcing face having a first forcing point at a lateral side thereof, the second forcing face having a second forcing point at a lateral side thereof;
when the mounting portion is mounted on a damaged screw member, the first forcing face contacts a damaged corner of the damaged screw member, and the second forcing point rests on a lateral face of the damaged screw member, such that other damaged corners of the damaged screw member are housed in the recess portions.

2. The damaged screw member removing tool of claim 1, wherein each recess portion includes two lateral sides and an arc section disposed between the two lateral sides; the two lateral sides connected with the first forcing face and the second forcing face, respectively; a length of the two lateral sides is small than a length of the first forcing face and the second forcing face.

3. The damaged screw member removing tool of claim 2, wherein a vertical distance from the first forcing face or the second forcing face to a rotation center of the mounting portion is defined as a first length; a vertical distance from the arc section to the rotation center of the mounting portion is defined as a second length; the second length is larger than the first length.

4. The damaged screw member removing tool of claim 2, wherein the first forcing point is disposed at a junction of the first forcing face and one of the lateral side; the second forcing point is disposed at a junction of the second forcing face and the other lateral side.

5. The damaged screw member removing tool of claim 2, wherein the first forcing face and the second forcing face include a 90 degrees angle with the two lateral sides, respectively.

6. The damaged screw member removing tool of claim 2, wherein a length of the first forcing face is defined as a third length; a straight line extending from the first forcing point or the second forcing point to a middle point of the arc section is defined as an extension line, and a length of the extension line is defined as a fourth length; the third length is larger than the fourth length.

7. The damaged screw member removing tool of claim 6, wherein the third length is larger than 1.5 to 2 times the fourth length, and the third length is equal to a length of the second forcing face.

8. The damaged screw member removing tool of claim 1, wherein the first forcing face and the second forcing face are formed in a planar shape.

9. The damaged screw member removing tool of claim 1, wherein a housing groove is disposed at a connection junction of the first forcing face and the second forcing face.

10. The damaged screw member removing tool of claim 9, wherein the first forcing point is arranged at one side of the first forcing face away from the housing groove, and the second forcing point is arranged at one side of the second forcing face away from the housing groove.

11. The damaged screw member removing tool of claim 9, wherein the housing groove is formed in an arc shape.

12. The damaged screw member removing tool of claim 1, wherein the included angle ranges between 90 degrees to 180 degrees.

13. The damaged screw member removing tool of claim 12, wherein the included angle is 120 degrees.

14. The damaged screw member removing tool of claim 1, wherein the main body includes a handle connected with the mounting portion, and the mounting portion is bent toward the handle by a bending angle which is smaller than 20 degrees.
